(19) United States
(12) Patent Application Publication
(10) Pub. No.: US 2015/0317549 A1
(43) Pub. Date: Nov. 5, 2015

(54) COLOR PROCESSING APPARATUS, IMAGE FORMATION SYSTEM, AND NON-TRANSITORY COMPUTER READABLE MEDIUM

(71) Applicant: FUJI XEROX CO., LTD., Tokyo (JP)

(72) Inventor: Takuhiro Togashi, Kanagawa (JP)

(21) Appl. No.: 14/511,358

(22) Filed: Oct. 10, 2014

(30) Foreign Application Priority Data
Apr. 30, 2014 (JP) 2014-093934

(51) Int. Cl. G06K 15/02

(52) U.S. Cl. CPC G06K 15/1878; G06K 15/027; G06K 2215/0094

(57) ABSTRACT

A color processing apparatus includes a job information acquiring unit, first and second timing determining units and a conversion relationship creating unit. The job information acquiring unit acquires information relating to an image formation job performed by an image forming unit. The first timing determining unit determines a first timing, at which a conversion relationship for color adjustment of an image formed by the image forming unit is created, based on the acquired information relating to the job. The second timing determining unit determines a second timing, at which power is supplied to a color information acquiring unit which acquires color information of images for color measurement for color adjustment, based on the determined first timing. The conversion relationship creating unit creates the conversion relationship based on the color information acquired by the color information acquiring unit.

### CROSS-REFERENCE TO RELATED APPLICATIONS

This application is based on and claims priority under 35 USC 119 from Japanese Patent Application No. 2014-093934 filed on Apr. 30, 2014, the entire content of which is incorporated herein by reference.

### BACKGROUND

### Technical Field

The present invention relates to a color processing apparatus, an image formation system, and a non-transitory computer readable medium.

### SUMMARY

According to an aspect of the present invention, it provides a color processing apparatus comprising: a job information acquiring unit that acquires information relating to an image formation job performed by an image forming unit; a first timing determining unit that determines a first timing, at which a conversion relationship for color adjustment of an image formed by the image forming unit is created, based on the acquired information relating to the job; a second timing determining unit that determines a second timing, at which power is supplied to a color information acquiring unit which acquires color information of images for color measurement for color adjustment, based on the determined first timing; and a conversion relationship creating unit that creates the conversion relationship based on the color information acquired by the color information acquiring unit.

### BRIEF DESCRIPTION OF THE DRAWINGS

Exemplary embodiment(s) of the present invention will be described in detail based on the following figures, wherein

FIG. 1 is a diagram showing an overall configuration example of an image formation system according to an embodiment;

FIGS. 2A and 2B are diagrams illustrating an image reading apparatus;

FIG. 3 is a block diagram showing a signal processing system in a controller;

FIG. 4 is a diagram showing a functional configuration example of a color processing unit;

FIGS. 5A and 5B are diagrams illustrating internal setting information which is set by a setting unit;

FIG. 6 is a flowchart illustrating an operation of a color processing unit according to a first embodiment;

FIG. 7 is a diagram illustrating a method for determining a first timing by a first timing determining unit according to the first embodiment;

FIG. 8 is a diagram showing an example in which images for color measurement are printed in margins on pages;

FIG. 9 is a diagram showing a state where the page on which the images for color measurement are printed is interposed between pages to be printed by a job being executed; and

FIG. 10 is a flowchart illustrating an operation of a color processing unit according to a second embodiment.

### DETAILED DESCRIPTION

### Description of Overall Configuration of Image Formation Apparatus

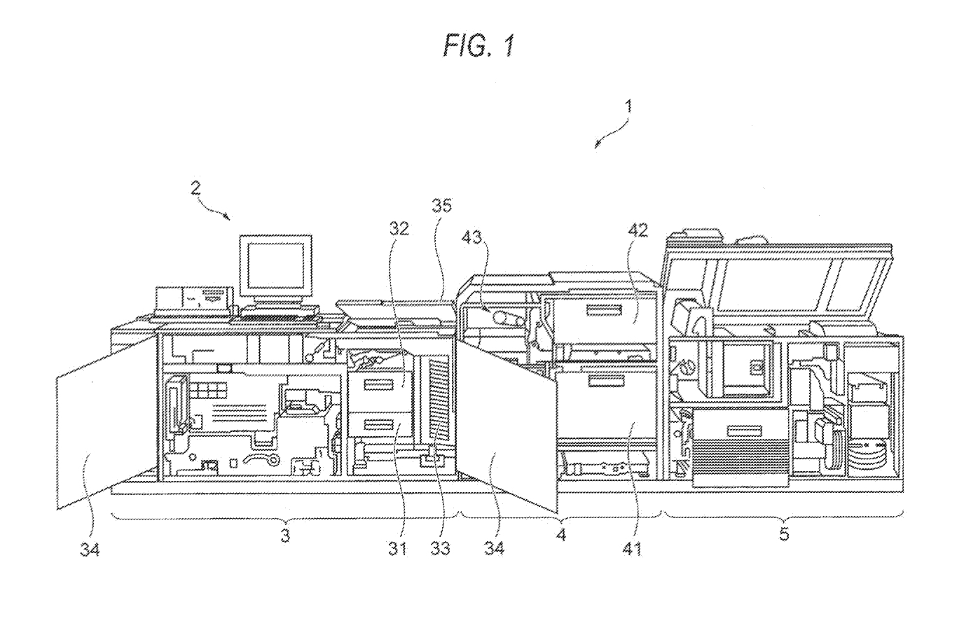

FIG. 1 is a diagram showing an overall configuration example of an image formation system 1 according to an embodiment.

The image formation system 1 is provided with a controller 2 for controlling the respective functional components in the image formation system 1 and an image forming unit 3 as a print mechanism for forming images on sheets (recording materials, recording media).

In addition, the image formation system 1 is further provided with a sheet accommodation unit 4 for accommodating sheets to be used by the image forming unit 3 and a post-processing unit 5 for performing post-processing of the sheets after the images are formed thereon by the image forming unit 3.

The controller 2 in the image formation system 1 is connected to a network which is not shown in the drawing and receives print data (image data) from a PC (personal computer) or the like, which is not shown in the drawing, via the network. In addition, the controller 2 performs necessary image processing such as color adjustment and transmits the print data to the image forming unit 3 as will be described later. The controller 2 may be provided with an input device such as a touch panel or a keyboard, for example.

The image forming unit 3 forms an image on a sheet by using plural colorants. The image forming unit 3 is an electrophotographic type, for example, in the embodiment. That is, a photoconductor formed into a drum shape, for example, is uniformly charged, the photoconductor is exposed to light controlled based on the print data, and an electrostatic latent image is formed on the photoconductor. Then, a developing device develops the electrostatic latent image to a visible image (toner image) by a toner as a colorant. Furthermore, the image is formed by transferring the toner image to the sheet and fixing the image thereon by application of heat and pressure from a fixing device.

In addition, the image forming unit 3 is not limited to the electrophotographic type and may be an ink jet type which uses ink as a colorant and forms an image by ejecting the ink onto a recording medium.

In addition, the image forming unit 3 is provided with sheet trays 31 and 32 separately from a sheet tray 41, which will be described later, of the sheet accommodation unit 4. Moreover, a transport system, which is not shown in the drawing, for transporting the sheet from the sheet trays 31 and 32 to the image forming unit 3 is further provided.

Furthermore, the image forming unit 3 is provided with a discharge tray unit 33. The sheet after the image is formed thereon by the image forming unit 3 is discharged to the discharge tray unit 33 in a case where post-processing by the post-processing unit 5 is not required.

In addition, the image forming unit 3 is provided with opening and closing covers 34 and 3S is designed such that maintenance such as adjustment of the respective mechanism components in the image forming unit 3, replacement of consumable supplies, and removal of a sheet in a case of jam (sheet clogging) can be performed by opening the opening and closing covers 34 and 35.

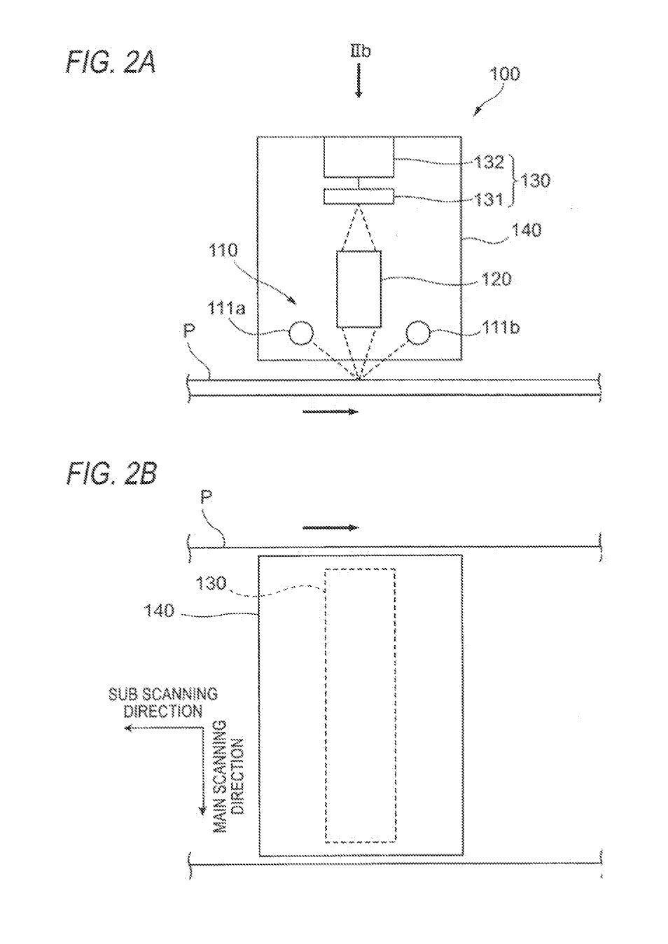

In addition, the image forming unit 3 is provided with an image reading device 100 (see FIGS. 2A and 2B) for reading the image fixed by the fixing device as will be described in detail later. The image reading device 100 functions as color information acquiring unit that acquires color information (color data) of images for color measurement which are used for color adjustment.

The sheet accommodation unit 4 is provided with the sheet trays 41 and 42. The sheet tray 41 and the sheet tray 42 can accommodate the sheets along with the sheet trays 31 and 32. A sheet corresponding to print data is selected by the controller 2, and the sheet is extracted from one of the sheet trays 31, 32, 41, and 42 and is transported from a transport system, which is not shown in the drawing, to the image forming unit 3.

The sheet accommodation unit 4 is an optional device, and it is possible to additionally provide the sheet accommodation unit 4 in a case where the sheet trays 31 and 32 in the image forming unit 3 cannot provide sufficient types of sheets. Therefore, the sheet accommodation unit 4 is not necessarily provided if the sheet trays 31 and 32 can provide sufficient types of sheets.

In addition, the sheet accommodation unit 4 includes a sheet transport unit 43 provided at an upper portion thereof. In a case where post-processing is performed by the post-processing unit 5, the sheet is transported from the image forming unit 3 to the post-processing unit 5 by the sheet transport unit 43.

The post-processing unit 5 performs post-processing such as cutting, folding, punching, filing, or binding on the sheet on which the image is formed. The post-processing unit 5 is also an optional device, and it is not necessary to connect the post-processing unit 5 in a case where post-processing is not required.

### <Description of Image Reading Device 100>

FIGS. 2A and 2B are diagrams illustrating the image reading device 100. Here, FIG. 2A is a diagram of the image reading device 100 when viewed in the same direction as that in FIG. 1. In addition, FIG. 2B is a diagram of the image reading device 100 when viewed from a 11b direction in FIG. 2A.

As shown in the drawing, the image reading device 100 is provided with a light source 110, an optical system 120, a CCD (charge coupled device) sensor 130, and a case body 140.

The light source 110 irradiates a sheet P, on which an image is formed, with light. The light source 110 is configured of a pair of tungsten lamps 111a and 111b, for example. In addition, the light source 110 irradiates the image formed on the sheet P with light and generates reflected light including information of the image.

The optical system 120 guides the light reflected by the image, which is formed on the sheet P to the CCD sensor 130. According to the embodiment, the optical system 120 is configured of a Selfoc Lens Array (SLA: registered trademark) as a lens array. In addition, the Selfoc Lens Array mainly collects diffused reflected light among the reflected light from the image, and the CCD sensor 130 is made to form an image.

The CCD sensor 130 receives the light guided by the optical system 120. In the CCD sensor 130, CCDs 131 as pixels for receiving light reflected by the image are arranged in a line. According to the embodiment, the CCDs 131 corresponding to the respective colors, namely R (red), (i (green), and B (blue) are aligned in three arrays, and an image can be measured based on the respective colors of R, G, and B. That is, the CCDs 131 are three-line-color CCDs. The number of CCDs 131 aligned for each color at a pitch of 40 μm is 7488. That is, it is possible to read an image in a main scanning direction with 7488 pixels. The light received by the CCDs 131 is subjected to photoelectric conversion and is converted into an electrical charge, and the electrical charge is transferred to a light intensity value generating unit 132.

The light intensity value generating unit 132 detects the electrical charge transferred from the CCDs 131 and generates a detection signal. The detection signal functions as light intensity data which is color data used by the image forming unit 3 for performing color adjustment. That is, the color intensity value generating unit 132 creates, as light intensity value data, the color data which is used by the image forming unit 3 for performing the color adjustment from the light received by the CCDs 131. In addition, since the CCDs 131 are three-color CCDs for R (red), G (green), and B (blue), the color intensity value generating unit 132 generates an R signal, a G signal, and a B signal as light intensity value data corresponding to the respective colors.

The case body 140 is a case for accommodating the light source 110, the optical system 120, and the CCD sensor 130 therein.

### <Functional Configuration Example of Controller 2>

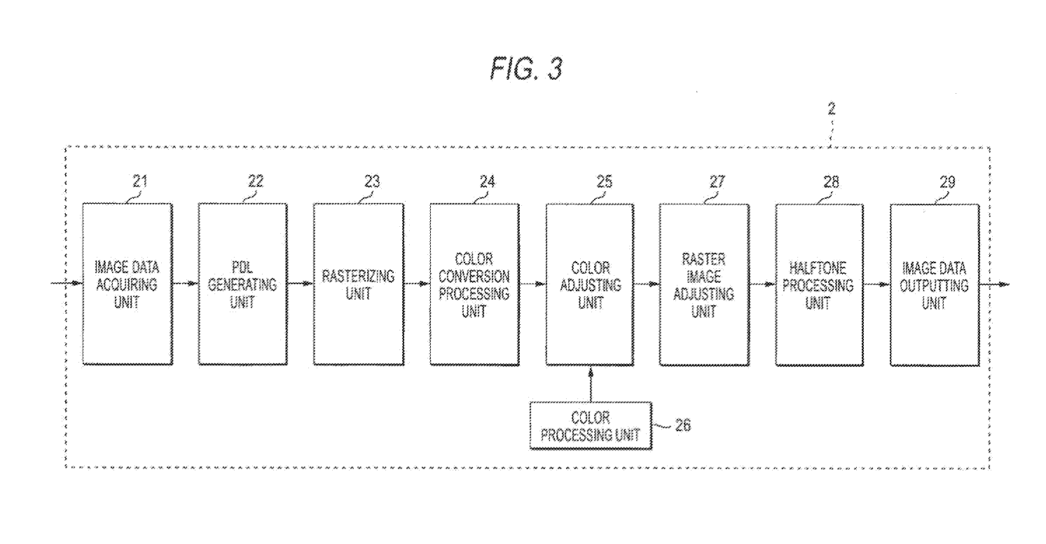

FIG. 3 is a block diagram showing a signal processing system in the controller 2.

The controller 2 is provided with an image data acquiring unit 21 which acquires print data created by the image forming unit 3 for outputting an image, a PDL generating unit 22 which receives the print data and converts the print data into a page description language (PDL), a rasterizing unit 23 which creates a raster image from the PDL generated by the PDL generating unit 22, a color conversion processing unit 24 which converts RGB data into CMYK data, a color adjusting unit 25 which performs color adjustment of the CMYK data, a color processing unit 26 which creates a profile for performing the color adjustment by the color adjusting unit 25, a raster image adjusting unit 27 which adjusts the raster image converted by the color adjusting unit 25, a halftone processing unit 28 which performs halftone processing, and an image data outputting unit 29 which outputs the print data after signal processing to the image forming unit 3.

According to the embodiment, the image data acquiring unit 21 receives print data from an external PC first. The print data is image data that a user of the PC desires to print by the image forming unit 3.

Then, the print data is transmitted to the PDL generating unit 22, and the PDL generating unit 22 converts the print data into code data described in a PDL and outputs the code data.

The rasterizing unit 23 converts the code data described in the PDL, which is output from the PDL generating unit 22, into raster data of the respective pixels and obtains a raster image. In addition, the rasterizing unit 23 outputs the raster data after the conversion as video data (RGB data) of RGB (red, green, and blue). At this time, the rasterizing unit 23 outputs the RGB data for each page.

The color conversion processing unit 24 converts the RGB data, which is input from the rasterizing unit 23, into device-independent XYZ color values, then converts the color values into CMYK data of reproductive colors (toner colors as colorants: cyan (C), magenta (M), yellow (Y), and black (K)) of the image forming unit 3, and outputs the CMYK data. The CMYK data is configured of Y-color data, M-color data, C-color data, and K-color data which are split for the respective colors.

The color adjusting unit 25 is an example of the color adjustment member for performing color adjustment of the image formed by the image forming unit 3. The color adjusting unit 25 performs color adjustment of the CMYK data so as to match targeted colors which should originally be output by the image forming unit 3 in accordance with the CMYK data as will be described later. In such a case, the color adjustment is processing of converting CᵢₙMᵢₙYᵢₙKᵢₙ data into CₒᵤₜMₒᵤₜYₒᵤₜKₒᵤₜ, data ((CᵢₙMᵢₙYᵢₙKᵢₙ)→(CₒᵤₜMₒᵤₜYₒᵤₜKₒᵤₜ)). According to the embodiment, the conversion is performed by using a so-called device link profile for directly converting the CᵢₙMᵢₙYᵢₙKᵢₙ data into the CₒᵤₜMₒᵤₜYₒᵤₜKₒᵤₜ data in the same CMYK color space as that of the CᵢₙMᵢₙYᵢₙKᵢₙ data without converting the CᵢₙMᵢₙYᵢₙKᵢₙ data into data in a different color space such as an L*a*b color space.

According to the embodiment, the device link profile is an example of the conversion relationship for performing the color adjustment of the image formed by the image forming unit 3 and is created as a four-dimensional LUT (look up table), for example. Hereinafter, the four-dimensional LUT will be simply referred to as a “LUT” in some cases.

The color processing unit 26 is an example of conversion relationship creation member (color processing device) for creating the LUT to be used by the color adjusting unit 25 for performing color adjustment. In addition, the color adjusting unit 25 stores the LUT created by the color processing unit 26 and performs the color adjustment by referring to the LUT.

The raster image adjusting unit 27 performs various kinds of adjustment processing such as y conversion, precision level processing, and middle tone processing on the CₒᵤₜMₒᵤₜYₒᵤₜKₒᵤₜ data input from the color adjusting unit 25 so as to obtain an image with more satisfactory quality by the image forming unit 3.

The halftone processing unit 28 performs halftone processing on the print data by dither mask processing using a dither mask which has a threshold alignment determined in advance in the main scanning direction and the sub scanning direction. By such processing, the print data is represented by multi-valued expression or binary expression.

The image data outputting unit 29 outputs the image data, on which image processing such as color conversion processing has been performed, to the image forming unit 3.

Here, colors of an image formed by the image forming unit 3 vary due to a change over time, for example, in some cases. In such cases, the colors of the output image do not coincide with targeted colors, and therefore, it is necessary to update the LUT to be used by the color adjusting unit 25 in order to cause the colors of the output image to coincide with the targeted colors. Hereinafter, the processing of updating the LUT will also be referred to as “calibration”.

In order to perform the calibration, there is a method in which images for color measurement (color patch) are printed by the image forming unit 3, colors of the printed images for color measurement are measured by a colorimeter, and an LUT is newly created based on color data obtained by the color measurement.

However, the method has a problem in that a user should stop the image forming unit 3 and additionally perform the color measurement, and therefore, execution of print jobs is suspended for a long time.

In addition, there is a method for performing the calibration, in which images for color measurement (color patch) as toner images are placed on a transfer belt used for transferring images and colors of the images for the color measurement are measured by a sensor for color measurement used in the image forming unit 3. Moreover, there is a problem in that colors of formed images for color measurement are measured by the image reading device 100, which was described with reference to FIGS. 2A and 2B, after passing through the fixing device.

However, according to these methods in the related art, the execution of print jobs is stopped, and the sequence necessary for the calibration is started after the stopping of the print jobs, and a time during which the print jobs are stopped becomes long. Particularly, in a case where the light source 110 used in the image reading device 100 has a short lifetime, there is a problem in that a duration time of the light source 110 is shortened if the light source 110 is continuously turned on. Therefore, the light source 110 is turned on after the stopping of the print jobs in the related art. In addition, since it takes a time for the light source 110 to stabilize a color and an amount of light from the light source 110 after the turning on, there is a problem in that the print jobs are stopped for a long time.

Thus, according to the embodiment, the color processing unit 26 is configured as will be described below in order to suppress the above problem.

### <Functional Configuration Example of Color Processing Unit 26>

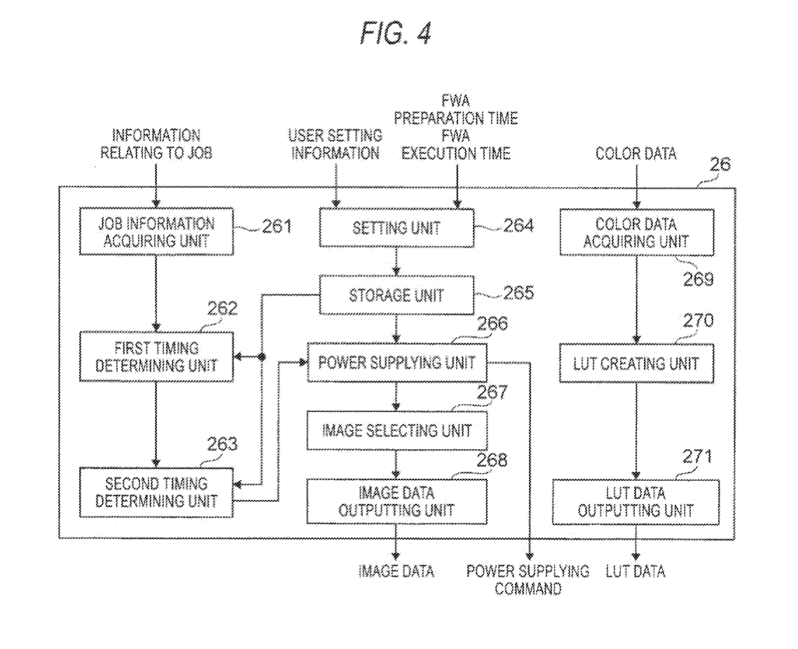

FIG. 4 is a diagram illustrating a functional configuration example of the color processing unit 26.

As shown in the drawing, the color processing unit 26 according to the embodiment is provided with a job information acquiring unit 261, a first timing determining unit 262, a second timing determining unit 263, a setting unit 264, a storage unit 265, a power supplying unit 266, an image selecting unit 267, an image data outputting unit 268, a color data acquiring unit 269, an LUT creating unit 270, and an LUT data outputting unit 271.

The job information acquiring unit 261 acquires information relating to a job (print job) for image formation to be performed by the image forming unit 3. The information relating to the job for image formation includes a job ID, a size of a sheet on which the image formation is performed, and a number of pages on which the image formation is performed as will be described in detail later.

The first timing determining unit 262 determines, based on the acquired information relating to the job, a first timing for creating an LUT for performing color adjustment of the image formed by the image forming unit 3.

The first timing is a clock time at which some job is completed, for example, as will be described later.

The second timing determining unit 263 determines, based on the determined first timing, a second timing at which power is supplied to the image reading device 100.

That is, the light source 110 used in the image reading device 100 has a short lifetime as described above, and therefore, the duration time thereof is shortened if the light source 110 is continuously turned on. Therefore, it is possible to extend the duration time of the light source 110 by supplying power to the image reading device 100 at an appropriate timing. In addition, there is a case where it takes a time for the light source 110 to be stabilized, and in such a case, the light source 110 is stabilized by supplying power to the image reading device 100 at an appropriate timing in the same manner.

The second timing is a timing before the first timing which is determined by the first timing determining unit 262 as will be described in detail later. The “supplying power” described herein does not mean that power is simply supplied to the image reading device 100 but means that power is supplied to the light source 110 provided in the image reading device 100.

The setting unit 264 sets internal setting information for setting the first timing and the second timing.

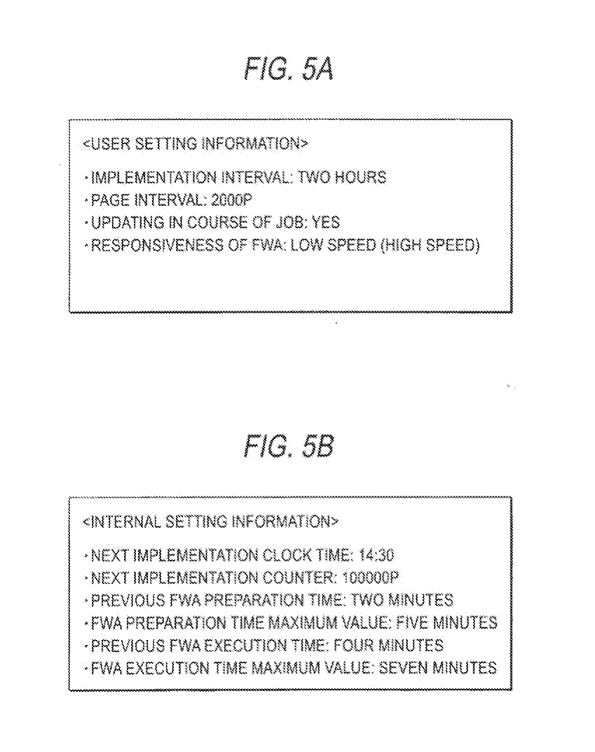

FIGS. 5A and 5B are diagrams illustrating the internal setting information set by the setting unit 264.

Among the drawings, FIG. 5A is a diagram showing user setting information set by the user.

The user setting information shown in FIG. 5A is configured of four pieces of information, namely “an implementation interval”, “a page interval”, “updating in the course of job”, and “responsiveness of FWA”. Such user setting information can be input by the user using the input device such as a touch panel or a keyboard of the controller 2.

The “implementation interval” is an interval, at which the calibration is performed, and which is represented as a time. Here, two hours are set as the “implementation interval”.

In addition, the “page interval” is an interval, at which the calibration is performed, and which is represented as a number of pages. Here, 2000 pages (2000 p) are set as the “page interval”. That is, this means that the calibration is set to be performed once every 2000 pages and every two hours.

Furthermore, “Yes” in the “updating in the course of a job” means that a sequence for the calibration is permitted in the course of execution of the job.

As for the “responsiveness of FWA”, FWA is an abbreviation of a “Full Width Array” and means the image reading device 100. For the “responsiveness of FWA”, a high speed or a low speed is set depending on whether or not background processing, which will be described later, can be performed. That is, a case where a high speed is set for the “responsiveness of FWA” corresponds to a case where the background processing can be performed, and a case where a low speed is set for the “responsiveness of FWA” corresponds to a case where the background processing cannot be performed.

The user setting information as described above is sent to the setting unit 264, and the internal setting information is set.

FIG. 5B is a diagram showing the internal setting information set by the setting unit 264 based on the user setting information.

The internal setting information shown in FIG. 5B is configured of six pieces of information, namely a “next implementation clock time”, a “next implementation counter”, a “previous FWA preparation time”, an “FWA preparation time maximum value”, a “previous FWA execution time”, and an “FWA execution time maximum value”.

The “next implementation clock time” is a next implementation clock time at which the calibration is performed. Here, the drawing shows that 14:30 is set. This is a clock time set based on the information that the “implementation interval” is two hours in the user setting information.

In addition, the “next implementation counter” is the next number of counters for the calibration. Here, the drawing shows that 100000 pages (100000 p) are set as the next implementation counters. This is set based on the information that the “page interval” is 2000 pages in the user setting information. In addition, 100000 pages correspond to the total number of printed pages on a day on which the printing is performed, for example.

In addition, the “previous FWA preparation time” is time required by the image reading device 100 for performing the preparation sequence when the calibration was performed last time. Here, it is possible to know that the “previous FWA preparation time” was two minutes. The time for the preparation sequence includes a preparation time of the light source 110 and a time required by the image selecting unit 267, which will be described later, for preparing image data of the images for the color measurement.

In addition, the “FWA preparation time maximum value” is a maximum value of a time required by the image reading device 100 for performing the preparation sequence when the calibration was performed in the past. Here, it is possible to know that the “FWA preparation time maximum value” was five minutes.

The “previous FWA execution time” is a time required for the entire calibration sequence in which the image reading device 100 performs preparation, acquires color data of the images for the color measurement, and creates the LUT. Here, it is possible to know that the “previous FWA execution time” was four minutes. The calibration sequence is a sequence which includes the above preparation sequence, reading the images for the color measurement by the image reading device 100 after the completion of the preparation sequence, and creating the LUT by the LUT creating unit 270 based on the read color data.

In addition, the “FWA execution time maximum value” is a maximum value of a time required by the image reading device 100 for the entire calibration sequence when the calibration was performed in the past. Here, it is possible to know that the “FWA execution time maximum value” was seven minutes.

Returning to FIG. 4, the storage unit 265 stores the internal setting information set by the setting unit 264. In addition, the storage unit 265 also stores the image data of the images for the color measurement selected by the image selecting unit 267 which will be described later. A pattern of the images for the color measurement is determined in advance, and the storage unit 265 stores the image data of the images for the color measurement in advance.

The power supplying unit 266 waits for a clock time corresponding to the second timing at which power is supplied to the image reading device 100 and supplies power to the image reading device 100 at the clock time.

The image selecting unit 267 selects the images for the color measurement. As the images for the color measurement, images obtained by setting halftone dot area ratios (coverage, Cin), for example, of the respective plain colors, namely CMYK, to twenty one levels from 0% to 100% are used. In such a case, twenty one images for color measurement are selected for each of the CMYK colors.

In addition, two-dimensional-color images obtained by mixing two colors or three-dimensional-color images obtained by mixing three colors among the CMYK colors may be prepared as the images for the color measurement.

The image data outputting unit 268 outputs image data of the images for the color measurement which are selected by the image selecting unit 267.

The image forming unit 3 prints the images for the color measurement on a sheet. The colors of the printed images for the color measurement are read by the image reading device 100. Then, the image reading device 100 transmits the color data, which is obtained by reading the images for the color measurement, to the color processing unit 26 of the controller 2. At this time, the color data output from the image reading device 100 is L*a*b* data configured of respective color data, namely L* data, a* data, and b* data in the L*a*b* color space, for example.

The color data acquiring unit 269 acquires the color data of the images for the color measurement, which is transmitted by the image reading device 100.

The LUT creating unit 270 is an example of the conversion relationship creating unit and creates the LUT based on the color data acquired by the image reading device 100.

In such a case, the LUT creating unit 270 creates the LUT based on the color data of the images for the color measurement after the formation thereof on the sheet. By the processing, color adjustment is performed in consideration of a color tone of the sheet.

The LUT data outputting unit 271 sends, as LUT data, the LUT created by the LUT creating unit 270 to the color adjusting unit 25. The color adjusting unit 25 stores the newly created LUT. Then, color conversion of (Cᵢₙ, Mᵢₙ, Yᵢₙ, Kᵢₙ)→(Cₒᵤₜ, Mₒᵤₜ, Yₒᵤₜ, Kₒᵤₜ) is performed based on the newly created LUT.

### Description of Operation of Color Processing Unit 26

### First Embodiment

Next, a description will be given of an operation of the color processing unit 26. First, a first embodiment of the color processing unit 26 will be described herein. The first embodiment corresponds to a case where the color processing unit 26 can perform an operation as background processing. That is, a description will be given of a case where it is possible to acquire the image data of the images for the color measurement from the image reading device 100 and to create the LUT during execution of a job by the image forming unit 3.

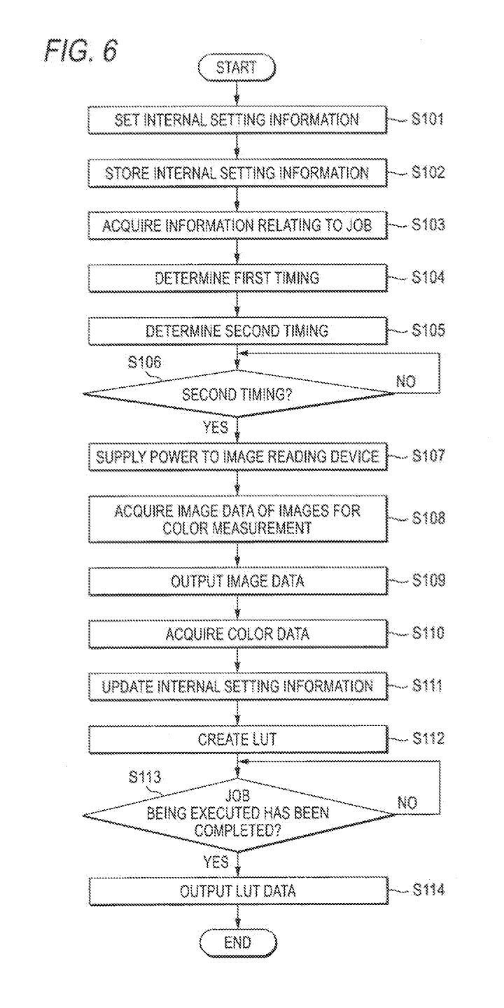

FIG. 6 is a flowchart illustrating the operation of the color processing unit 26 according to the first embodiment.

Hereinafter, a description will be given of the operation of the color processing unit 26 with reference to FIGS. 4 and 6.

First, the setting unit 264 acquires user setting information as shown in FIG. 5A and sets internal setting information as shown in FIG. 5B (Step 101). The internal setting information is stored on the storage unit 265 (Step 102).

Next, the job information acquiring unit 261 acquires information relating to an image formation job to be performed by the image forming unit 3 (Step 103). The information relating to the job includes a job ID, a size of a sheet to be used for the image formation, and a number of pages on which the image formation is performed, as described above.

Then, the first timing determining unit 262 determines a first timing for creating an LUT from the acquired information relating to the job (Step 104). According to the embodiment, the first timing corresponds to a clock time at which a job executed from the “next implementation clock time” is completed in FIG. 5B.

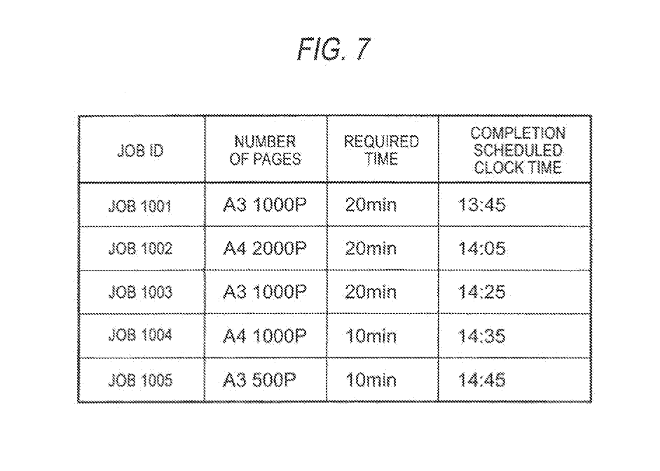

FIG. 7 is a diagram showing a method of determining the first timing by the first timing determining unit 262 according to the first embodiment.

As shown in the drawing, the first timing determining unit 262 estimates necessary times required for performing the respective jobs and completion scheduled clock time of the respective jobs based on sizes of the sheets to be used for the image formation and numbers of pages on which the image formation is performed. Here, in a case of a job with a job ID “Job 1001”, the necessary time is estimated to be twenty minutes, and the completion schedule clock time is estimated to be 13:45. In addition, in a case of a job with a job ID “Job 1002”, the necessary time is estimated to be twenty minutes, and the completion scheduled clock time is estimated to be 14:05. Similarly, in cases of jobs with job IDs “Job 1003”, “Job 1004”, and “Job 1005”, necessary times are estimated to be twenty minutes, ten minutes, and ten minutes, respectively, and the completion scheduled clock times are estimated to be 14:25, 14:35, and 14:45, respectively.

Then, the first timing determining unit 262 refers to the internal setting information in FIG. 5S and finds a completion scheduled clock time at which a job performed from 14:30 corresponding to the next implementation clock time set for the calibration is completed. In such a case, the job estimated to be performed from 14:30 is “Job 1004”, and the completion scheduled clock time of the job is 14:35. Then, the first timing determining unit 262 sets 14:35 as the first timing.

Returning to FIGS. 4 and 6, the second timing determining unit 263 then determines a second timing, at which power is supplied to the image reading device 100, based on the determined first timing (Step 105).

According to the embodiment, the second timing determining unit 263 refers to the “FWA execution time maximum value” in the internal setting information in FIG. 5B. As for the second timing, the second timing determining unit 263 then sets a clock time obtained by subtracting the “FWA execution time maximum value” from the first timing as the second timing. Here, the second timing determining unit 263 subtracts seven minutes corresponding to the “FWA execution time maximum value: from 14:35 corresponding to the first timing and determines 14:28 as the second timing.

Thereafter, the power supplying unit 266 determines whether or not a current clock time has reached 14:28 corresponding to the second timing at which power is supplied to the image reading device 100 (Step 106).

Then, if the current clock time has not reached 14:28 corresponding to the second timing (No in Step 106), the processing returns to Step 106. In contrast, if the current time has reached 14:28 corresponding to the second timing (Yes in Step 106), the power supplying unit 266 supplies power to the image reading device 100 (Step 107). In practice, the power supplying unit 266 transmits a command or the like, which instructs power supply, to the image reading device 100.

Then, after the preparation sequence of the image reading device 100, the image selecting unit 267 selects images for color measurement, refers to the storage unit 265, and acquires image data of the images for the color measurement (Step 108).

Furthermore, the image data outputting unit 268 outputs the image data of the images for the color measurement (Step 109).

At this time, the images for the color measurement printed by the image forming unit 3 are printed during execution of “Job 1004”. In order to do so, it is considered that the images for the color measurement are printed in margins on pages printed for “Job 1004” being executed.

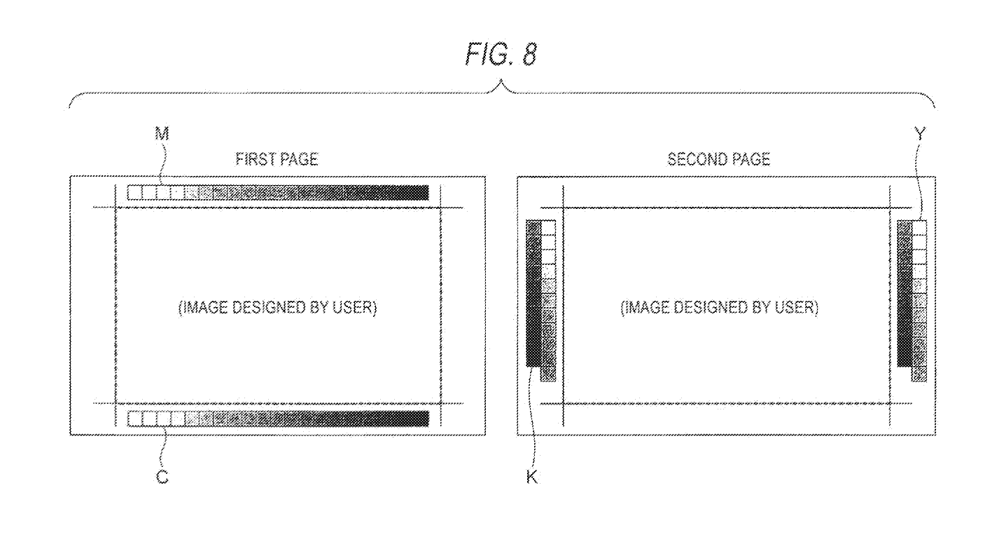

FIG. 8 is a diagram showing an example in which the images for the color measurement are printed in margins on pages.

The images in the drawing are images corresponding to two pages, and images designed by the user are formed at centers of the respective sheets. In FIG. 8, the ranges are represented by dotted lines. In addition, images for color measurement for the C (cyan) color and the M (magenta) color are printed in margins at a lower portion and an upper portion on the first page in the drawing. Moreover, images for color measurement for the Y (yellow) color and the K (black) color are printed in margins at a right portion and a left portion on the second page in the drawing. In this case, the image for the color measurement for each color is twenty one images for the color measurement, which are obtained by setting halftone dot area ratios (coverage, Cin) to twenty one levels from 0% to 100%.

In such a case, the margins are portions which are to be removed by being cut, for example, by the post-processing unit 5 (see FIG. 1) later, and there is no problem if the images for the color measurement are printed therein.

In a case where there is no such a margin, it is possible to consider that a page, on which the images for the color measurement are printed, is interposed between pages on which printing is performed based on the job being executed.

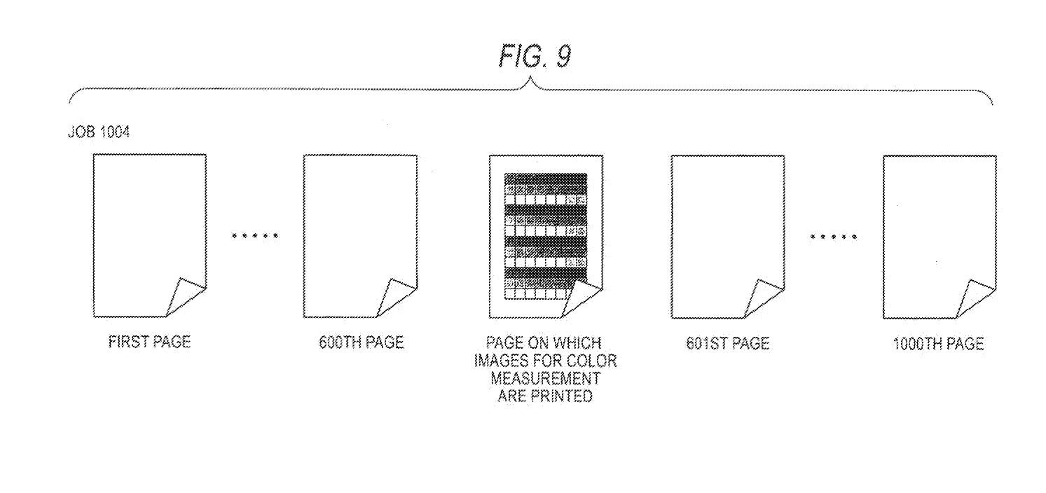

FIG. 9 is a diagram showing a state where the page on which the images for the color measurement are printed is interposed between the pages on which printing is performed based on the job being executed.

Here, the job “Job 1004” being executed is assumed to be a job for printing 1000 pages, for example, and a state where the page on which the images for the color measurement are printed is interposed between the 600^{th} page and the 601st page is shown. In such a case, the page on which the images for the color measurement is output separately from the pages, on which printing is performed based on the job being executed, in the final stage. For example, it is possible to consider that the page is discharged to a different purge tray, for example.

The images for the color measurement which are printed by the method described with reference to FIG. 8 or 9 are read by the image reading device 100. As a result, color data of the acquired images for the color measurement is acquired by the color data acquiring unit 269 (Step 110).

In addition, the time required for the preparation sequence of the image reading device 100 (FWA preparation time) and the time required for the calibration sequence (FWA execution time) are sent to the setting unit 264. Then, a part of the internal setting information stored on the storage unit 265 is updated (Step 111). Specifically, the “previous FWA preparation time” and the “previous FWA execution time” are updated.

In contrast, the LUT creating unit 270 creates a LUT based on the color data of the acquired images for the color measurement (Step 112). Steps 107 to 112 correspond to the calibration sequence, the LUT is created by the LUT creating unit 270 by 14:30 corresponding to the first timing, and the calibration sequence is completed. Since the light source 110 of the image reading device 100 may be turned off if the color data of the images for the color measurement, which is necessary for creating the LUT, is acquired, it might be shortened the time during which the light source 110 of the image reading device 100 is turned on.

Next, the LUT data outputting unit 271 determines whether or not the job “Job 1004” being executed has been completed (Step 113). If the job being executed has not been completed (No in Step 113), then the processing returns to Step 113. In contrast, if the job being executed has been completed (Yes in Step 113), then the LUT data outputting unit 271 sends, as LUT data, the LUT created by the LUT creating unit 270 to the color adjusting unit 25 (Step 114).

According to the first embodiment as described above, power is supplied to the image reading device 100 at 14:28 (second timing) at which “Job 1004” is being executed. This is a timing during execution of a former job among subsequent jobs. The clock time is obtained by taking the “FWA execution time maximum value” into consideration. For this reason, it is possible to execute the preparation sequence of the image reading device 100 and further to complete the processing of creating the LUT based on the color data obtained by the image reading device 100 by 14:35 (first timing) corresponding to a completion clock time of “Job 1004”. In addition, the LUT can be immediately applied to “Job 1005” which is a next job.

According to the embodiment, it is possible to create the LUT during the execution of “Job 1004”, and it is not necessary to perform the calibration while stopping the execution of the job as in the related art. In addition, the LUT is applied to the next job “Job 1005”, and thus a color tone of the image does not vary during the execution of “Job 1004”. Furthermore, since it is necessary to turn on the light source 110 of the image reading device 100 for only a short time, and it is possible to extend the duration time even if the light source 110 has a short lifetime.

### Second Embodiment

Next, a description will be given of a second embodiment of the color processing unit 26. The second embodiment corresponds to a case where the color processing unit 26 cannot perform an operation as background processing. That is, a description will be given of a case where it is not possible to acquire the image data of the images for the color measurement from the image reading device 100 and to create the LUT during the execution of a job by the image forming unit 3.

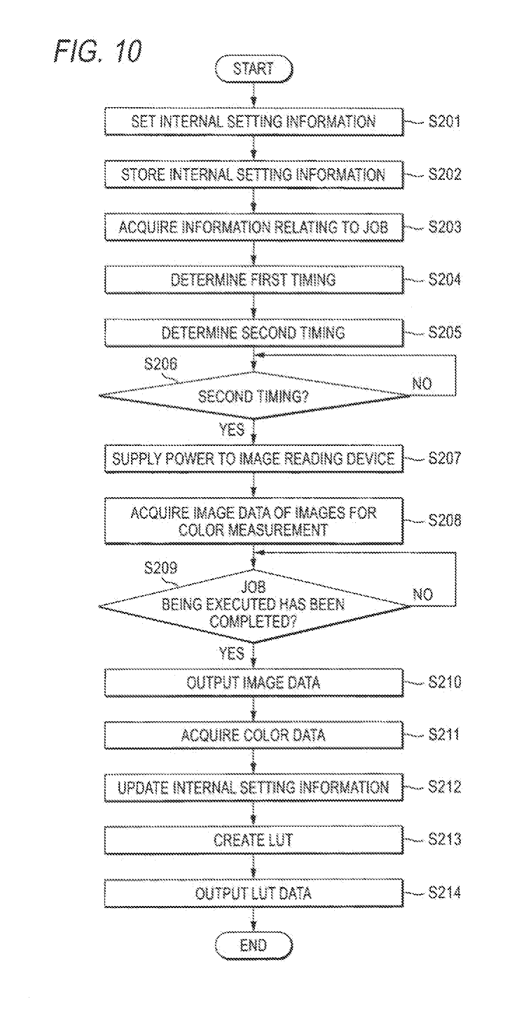

FIG. 10 is a flowchart illustrating an operation of the color processing unit 26 according to the second embodiment.

Hereinafter, a description will be given of the operation of the color processing unit 26 with reference to FIGS. 4 and 10.

Since operations in Steps 201 to 204 are the same as the operations in Steps 101 to 104 in FIG. 6, the description thereof will be omitted.

After the processing in Step 204, the second timing determining unit 263 determines the second timing at which power is supplied to the image reading device 100 based on the determined first timing (Step 205).

According to the embodiment, the second timing determining unit 263 refers to the “FWA preparation time maximum value” in the internal setting information in FIG. 5B. Then, as for the second timing, the second timing determining unit 263 sets a clock time obtained by subtracting the “FWA preparation time maximum value” from the first timing as the second timing. Here, the second timing determining unit 263 subtracts five minutes corresponding to the “FWA preparation time maximum value” from 14:35 corresponding to the first timing and determines 14:30 as the second timing.

Thereafter, the power supplying unit 266 determines whether or not the current clock time has reached 14:30 corresponding to the second timing at which power is supplied to the image reading device 100 (Step 206).

Then, if the current clock time has not reached 14:30 corresponding to the second timing (No in Step 206), the processing returns to Step 206. In contrast, if the current time has reached 14:30 corresponding to the second timing (Yes in Step 206), the power supplying unit 266 supplies power to the image reading device 100 (Step 207).

Next, the image selecting unit 267 selects the images for the color measurement, refers to the storage unit 265, and acquires image data of the images for the color measurement (Step 208). Steps 207 and 208 correspond to the preparation sequence of the image reading device 100, and the preparation sequence is completed by 14:30 corresponding to the first timing.

Then, the image data outputting unit 268 determines whether or not the job “Job 1004” being executed has been completed (Step 209). If the job being executed has not been completed (No in Step 209), then the processing returns to Step 209. In contrast, if the job being executed has been completed (Yes in Step 209), then the image data outputting unit 268 outputs the image data of the images for the color measurement (Step 210).

In such a case, the execution of the job is stopped once after the completion of “Job 1004”, and the image forming unit 3 prints the pages of the images for the color measurement.

Then, the printed images for the color measurement are read by the image reading device 100, and as a result, the color data of the acquired images for the color measurement is acquired by the color data acquiring unit 269 (Step 211).

A time required for the preparation sequence of the image reading device 100 and the calibration sequence is sent to the setting unit 264. Then, a part of internal setting information stored on the storage unit 265 is updated (Step 212).

In contrast, the LUT creating unit 270 creates an LUT for color adjustment based on the color data of the acquired images for the color measurement (Step 213).

Then, the LUT data outputting unit 271 sends, as LUT data, the LUT created by the LUT creating unit 270 to the color adjusting unit 25 (Step 214).

Thereafter, a new job “Job 1005” is started, and a newly created LUT is applied to “Job 1005”.

According to the second embodiment as described above, power is supplied to the image reading device 100 at 14:30 (second timing) at which “Job 1004” is being executed. This is also a timing during execution of a former job among subsequent jobs. This clock time is obtained by taking the “FWA preparation time maximum value” into consideration. Therefore, it is possible to complete the preparation sequence of the image reading device 100 and to output the image data of the images for the color measurement by 14:35 (first timing) corresponding to the completion clock time of “Job 1004”. According to the embodiment, it is possible to prepare the image reading device 100 during the execution of “Job 004” and to shorten the time, during which the job is stopped, as compared with a case where the preparation of the image reading device 100 is started after the job execution is stopped as in the related art. Furthermore, since it is necessary to turn on the light source 110 of the image reading device 100 for only a short time, it is possible to extend the duration time even in a case where the lifetime of the light source 110 is short.

By determining the second timing, at which power is supplied to the image reading device 100, based on the job completion scheduled time, the image forming unit 3 continuously prints the images for the color measurement after the job. Therefore, the calibration in this case is also performed in a similar state to that in the first embodiment in which the calibration is performed during the job execution.

Although the first timing is determined by using the “next implementation clock time” as the internal setting information in the examples of the first embodiment and the second embodiment as described above, the “next implementation counter” may also be used. In practice, one of these two, which has reached earlier, is used to determine the first timing.

In addition, although the completion clock time of the job being executed (the clock time at which subsequent jobs are switched or the clock time between the subsequent jobs) is applied as the first timing in the aforementioned examples, the invention is not limited thereto, and for example, the “next implementation clock time” may be set as the first timing as it is.

Furthermore, the “FWA execution time maximum value” and the “FWA preparation time maximum value” are used for determining the second timing in the aforementioned examples, the invention is not limited thereto, and a fixed time (such as ten minutes), for example, may be used.

### <Description of Program>

The processing performed by the color processing unit 26 according to the embodiment described hitherto is realized by cooperation of software and hardware resources. For example, the processing is performed by a control CPU, which is not shown in the drawing, in the controller 2 loading a program for realizing the respective functions of the color processing unit 26 on a memory which is not shown in the drawing and executing the program.

Therefore, the processing performed by the color processing unit 26 can also be understand as a program for causing a computer to realize a function of acquiring the information relating to an image formation job performed by the image forming unit 3, a function of determining the first timing at which the LUT for color adjustment of the image formed by the image forming unit 3 is created, a function of determining the second timing, at which power is supplied to the image reading device 100 for acquiring the color data of the images for the color measurement for the color adjustment, based on the determined first timing, and a function of creating the LUT based on the color data acquired by the image reading device 100.

In addition, the program which realizes the embodiments can be provided by communication means, of course, and can also be provided by being stored on a recording medium such as a CD-ROM.

Although the embodiments are described above, a technical scope of the invention is not limited to the scope described in the above embodiments. It is obvious from the description of the scope of claims that various modifications and improvements of the above embodiments are also included in the technical scope of the invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A color processing apparatus comprising:
a job information acquiring unit that acquires information relating to an image formation job performed by an image forming unit;
a first timing determining unit that determines a first timing, at which a conversion relationship for color adjustment of an image formed by the image forming unit is created, based on the acquired information relating to the job;
a second timing determining unit that determines a second timing, at which power is supplied to a color information acquiring unit which acquires color information of images for color measurement for color adjustment, based on the determined first timing; and
a conversion relationship creating unit that creates the conversion relationship based on the color information acquired by the color information acquiring unit.

2. The color processing apparatus according to claim 1,
wherein the first timing is determined as a timing between subsequent jobs, and the second timing is a timing during execution of a former job among the subsequent jobs.

3. The color processing apparatus according to claim 1,
wherein the conversion relationship creating unit completes the processing of creating the conversion relationship by the first timing.

4. The color processing apparatus according to claim 2,
wherein the conversion relationship creating unit completes the processing of creating the conversion relationship by the first timing.

5. The color processing apparatus according to claim 1,
wherein the conversion relationship creating unit creates the conversion relationship based on color information of the images for the color measurement after formation on a recording material.

6. The color processing apparatus according to claim 2,
wherein the conversion relationship creating unit creates the conversion relationship based on color information of the images for the color measurement after formation on a recording material.

7. The color processing apparatus according to claim 3,
wherein the conversion relationship creating unit creates the conversion relationship based on color information of the images for the color measurement after formation on a recording material.

8. An image formation system comprising:
an image forming unit that forms an image on a recording medium,
a color adjusting unit that performs color adjustment of the image formed by the image forming unit;
a conversion relationship creating unit that creates a conversion relationship used by the color adjusting unit which performs the color adjustment; and
a color information acquiring unit acquires color information of images for color measurement for color adjustment;
wherein the conversion relationship creating unit includes
a job information acquiring unit that acquires information relating to an image formation job performed by image forming unit,
a first timing determining unit that determines a first timing, at which the conversion relationship for color adjustment of an image formed by the image forming unit is created, based on the acquired information relating to the job,
a second timing determining unit that determines a second timing, at which power is supplied to the color information acquiring unit based on the determined first timing, and
a conversion relationship creating unit that creates the conversion relationship based on the color information acquired by the color information acquiring unit.

9. A non-transitory computer readable medium storing a program causing a computer to execute a process for color processing, the process comprising:
acquiring information relating to an image formation job performed by an image forming unit;
determining a first timing, at which a conversion relationship for color adjustment of an image formed by the image forming unit is created, based on the acquired information relating to the job;
determining a second timing, at which power is supplied to a color information acquiring unit which acquires color information of images for color measurement for color adjustment, based on the determined first timing; and
creating the conversion relationship based on the color information acquired by the color information acquiring unit.

10. The color processing apparatus according to claim 1,
wherein the color information acquiring unit is an image reading device for the color measurement.

11. The image formation system according to claim 8,
wherein the color information acquiring unit is an image reading device for the color measurement.

12. The non-transitory computer readable medium according to claim 9,
wherein the color information acquiring unit is an image reading device for the color measurement.
